(19) United States
(12) Patent Application Publication
(10) Pub. No.: US 2014/0301069 A1
(43) Pub. Date: Oct. 9, 2014

(54) LIGHT EMITTING DIODE LIGHT TUBE

(71) Applicant: GEM WELTRONICS TWN CORPORATION, Hsinchu County (TW)

(72) Inventors: JON-FWU HWU, Hsinchu County (TW); YUNG-FU WU, Hsinchu County (TW); KUI-CHIANG LIU, Hsinchu County (TW)

(73) Assignee: GEM WELTRONICS TWN CORPORATION, Hsinchu County (TW)

(21) Appl. No.: 13/858,212

(22) Filed: Apr. 8, 2013

(51) Int. Cl. F21V 3/04; F21K 99/00

(52) U.S. Cl. CPC F21V 3/0481; F21K 9/30
USPC 362/221; 362/217.01

(57) ABSTRACT

A Light Emitting Diode (LED) light tube includes a substrate having a light emitting side formed with a recess and at least one communication hole extending therethrough and at least one illumination unit disposed at a bottom of the recess. The illumination unit is constituted by a plurality of dies wire-bond together in series connection, thereby forming LED units. An optical layer and a protection layer are disposed to cover the relatively small width of the recess, thereby shielding the illumination unit.

### BACKGROUND OF THE INVENTION

1. Field of the Invention

The present invention relates to a Light Emitting Diode (LED) light tube, more particularly to an LED light tube, which can be produced in a shorter manufacturing time and is low in cost, thereby enhancing the product yield.

2. Description of the Prior Art

Owing to high efficient, long lasting, small size, low energy consuming, swift in response, and mature advance in the modern electronics lately, a majority of traditional bulbs or tubes are gradually replaced with LED light tubes. More specifically, LEDs are implemented in widely and largely used fluorescent tubes and hence an LED light tube becomes a major research topic among the manufacturers.

A prior art LED light tube generally includes a light tube, a heat dissipation plate, a printed circuit board, a plurality of LED units and two electrodes. The heat dissipation plate is mounted within the light tube while the printed circuit board is mounted on the heat dissipation plate. The LED units are connected electrically with the printed circuit board.

During the assembly, the LED units are first of all soldered on the printed circuit board, after which, the LED units and the printed circuit board are mounted on the heat dissipation plate via assembly elements. The above-mentioned elements are available in form of finished products, wherein the LED units are manufactured from wafer by high-tech companies, the dies by the medium size companies while the packing is done by small size companies. In addition, the printed circuit board is fabricated via etching, exposure process and coating process.

### SUMMARY OF THE INVENTION

A prior art LED light tube includes a plurality of LED units and a printed circuit plate which are fabricated through several processes and they are assembled together so as to form the LED light tube. The high tech companies usually fabricated wafers, which are transported to medium size companies, where the wafer is fabricated into dies, which is again wire bond and are molded by small size companies via molded compound to produce as the LED unit. It is notice that a large amount of molded compound consisting of fluorescent glue is required to conduct the molded process. The manufacturing cost is therefore high and consequently results in long manufacturing time.

The main objective of the present invention is to provide an LED light tube which includes a substrate having a light emitting side formed with a recess and at least one communication hole extending through said substrate and at least one illumination unit disposed at a bottom of the recess.

The LED light tube of the present invention further includes an optical layer covering the illumination unit. The optical layer is preferably made from fluorescent glue or material mixture consisting of fluorescent glue and silicon resin. The LED light tube of the present invention further includes two conductive rods that cooperatively define a conductive member and that extend through the communication holes in the substrate. The conductive rods have top ends connected electrically to the illumination unit.

In the present invention, the recess is relatively narrow in width and since the optical layer and the protection layer only need to cover the relatively small width of the recess for shielding the LED units, the cost of material expense is greatly reduced and hence shortening the manufacture time.

Unlike to the prior art LED light tube, where a leadframe is required for mounting of a respective LED unit, only two conductive rods are required for establishing with the electrical connection among plurality of the LED units of the present invention. Hence, the material cost can be cut down and the manufacturing process can be simplified.

The number of substrates and the illumination units employed in the LED light tube of the present invention can be adjusted in accordance with the user requirement, hence the LED light tube of the present invention can be fabricated in different length, thereby facilitating the user.

The number of substrates and the illumination units can be adjusted in accordance with the user requirement; hence the LED light tube of the present invention can be fabricated in different length, thereby facilitating the user.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is an LED light tube of the present invention viewed from a top side thereof;

FIG. 2 is a cross-sectional view illustrating a semi-product of an LED light tube of the present invention;

FIG. 3 shows a cross-sectional view illustrating the LED light tube of the present invention;

FIG. 4 shows a conduction member employed in the LED light tube of the present invention;

FIG. 5 shows how the conduction member is coupled in a substrate employed in the LED light tube of the present invention;

FIG. 6 shows an exploded view illustrating a modified LED light tube of the present invention;

FIG. 7 shows utilization of the substrate in the modified LED light tube of the present invention in a first way; and

FIG. 8 shows utilization of the substrate in the modified LED light tube of the present invention in a second way.

### DETAILED DESCRIPTION OF THE PREFERRED EMBODIMENTS

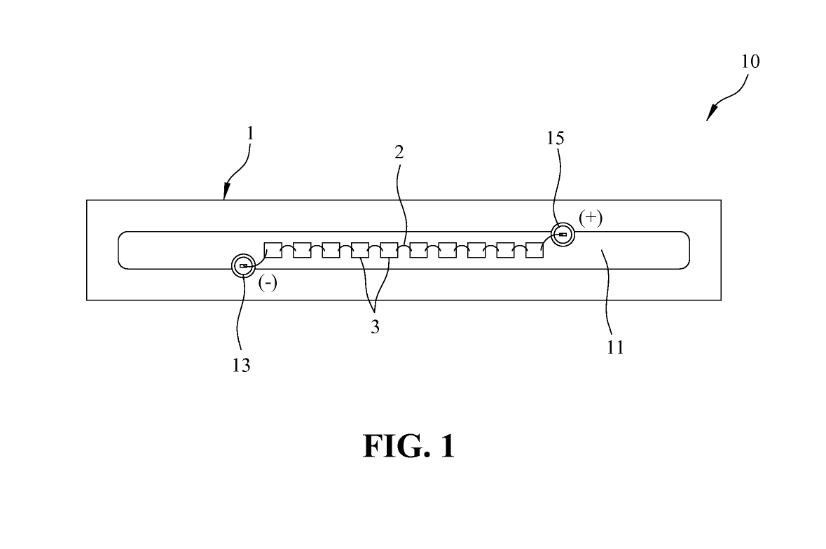

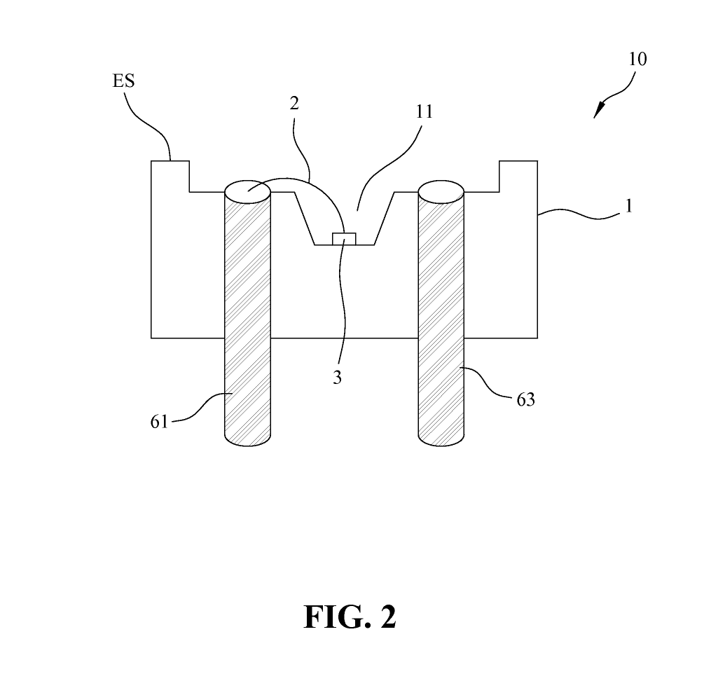

Referring to FIGS. 1 and 2, wherein FIG. 1 is a Light Emitting Diode (LED) light tube of the present invention viewed from a top side thereof and FIG. 2 is a cross-sectional view of the LED light tube of the present invention. As illustrated, the LED light tube 10 of the present invention includes a substrate 1 and at least one illumination unit. The substrate 1 has a light emitting side ES formed with a recess 11. The illumination unit is disposed at a bottom of the recess 11. The recess 11 has two lateral sides, each extending inclinedly from one end of the bottom within a range of 40°˜65°. Preferably, the substrate 1 is made from aluminum.

The illumination unit is constituted by three pieces of dies wire-bond together in series connection, thereby forming three LED units. Herein, gold wires or other conductive wires are used for electrically coupling the dies. The substrate 1 is further formed with a pair of communication holes 13, 15 extending therethrough. It is notice that the communication holes 13, 15 are staggered with respect to the opposite ends of the LED units.

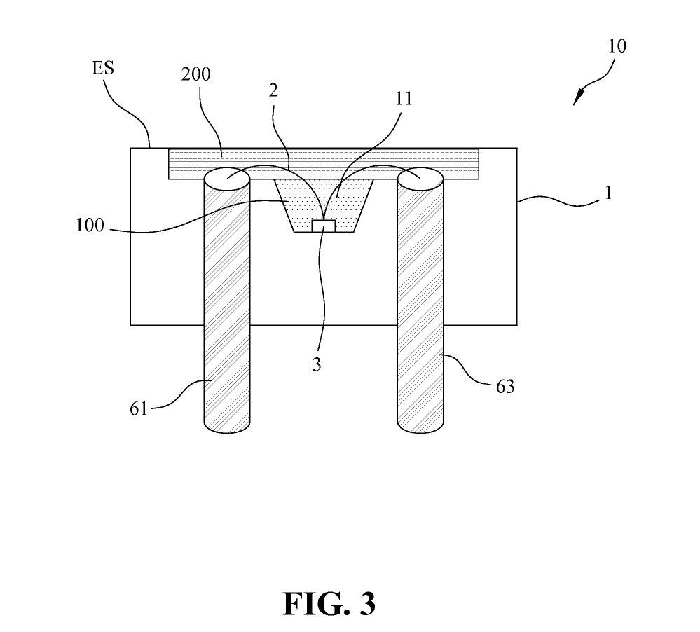

FIG. 3 shows a cross-sectional view of the LED light tube of the present invention. The LED light tube 10 of the present invention further includes an optical layer 100 covering the illumination unit so as to provide the optical effects, such as color mixing. The optical layer 100 is preferably made from fluorescent glue or material mixture consisting of fluorescent glue and silicon resin. The LED light tube 10 of the present invention further includes a protection layer 200 covering the optical layer 100 so as to isolate the vapor and dust from getting interior of the optical layer 100, thereby damaging the optical effects provided by the layer 100. Preferably, the protection layer 200 is mainly made from silicon resin.

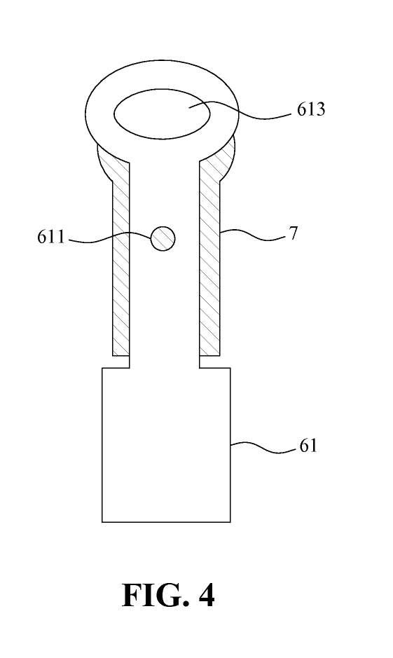

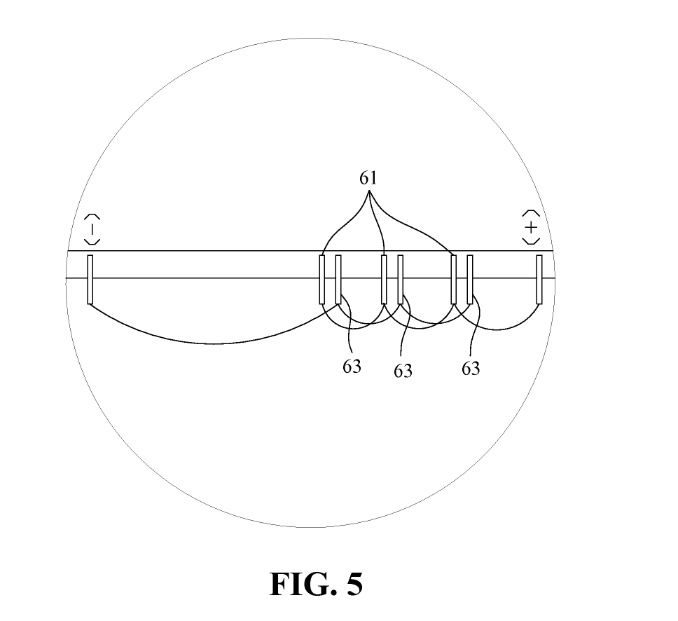

FIG. 4 shows a conduction member employed in the LED light tube of the present invention. FIG. 5 illustrates how the conduction member shown in FIG. 4 is coupled in a substrate employed in the LED light tube of the present invention. Also referring again to FIGS. 1 and 2, the LED light tube of the present invention further includes two conductive rods 61, 63 that cooperatively define a conductive member and that extend through the communication holes 13, 15 in the substrate 1, in which, an encapsulating material or molded compound is injected so as to immobilize the conductive rods 61, 63 stably therein.

In this embodiment, the molded compound 7 filled the through hole 611 interconnecting the communication holes 13, 15 so that the peripheries of the conductive rods 61, 63 abut tightly against the inner surface of the communication holes 13, 15. Under this condition, the conductive rods 61, 63 can be removed from the communication holes 13, 15 or inserted thereinto owing to the resiliency of the molded compound 7 and depending on the requirement of the utilization thereof. Preferably, the molded compound 7 is formed by at least one or a combination of silicon resin, liquid crystal polymer (LCP) and epoxy resin.

Referring to FIGS. 1 and 2 again, the LED light tube of the present invention further includes an LED driver (not visible) disposed with the substrate 1. The conductive rods 61, 63 have top ends connected electrically to the illumination unit and bottom ends connected electrically to the LED driver so that the latter generates a driving voltage to the conductive rods 61, 63 and hence drives the illumination unit, and causing the LEDs 3 to generate light. Preferably, the conductive rods 61, 63 are made from copper or any other metal so long as they provide electrical conduction. A silver layer 613 is coated over the top ends of the conductive rods 61, 63 to facilitate wire bonding operation.

In the event, a plurality of conductive members are implemented in the LED light tube of the present invention, the conductive rods 61, 63 are interactively connected together and are latter electrically coupled with the positive and negative terminals of the LED driver, thereby establishing electrical connection between the conductive members and the LED driver, as best shown in FIG. 5.

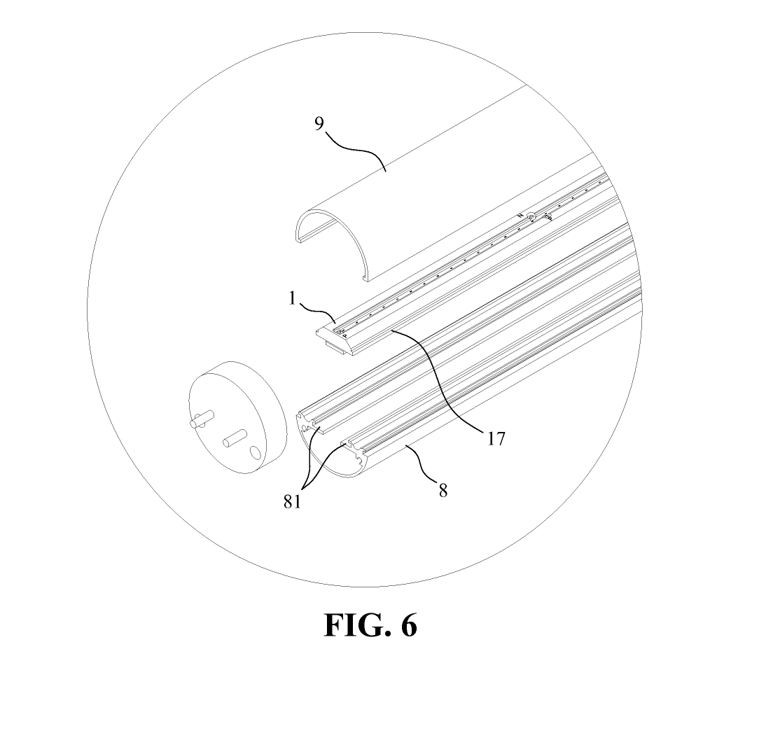

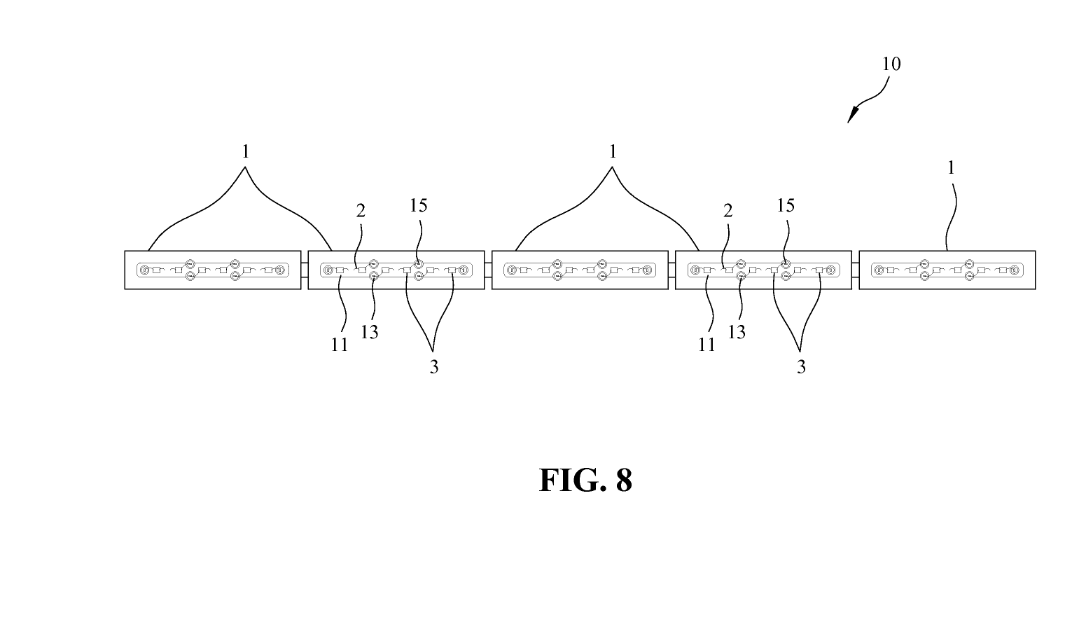

FIG. 6 shows an exploded view illustrating a modified LED light tube of the present invention. As illustrated, the modified LED light tube of the present invention is similar to the previous ones in structure, and further includes a heat dissipation plate 8 and a diffusion shield 9. The heat dissipation plate 8 is made from aluminum, has semi-circle shape and is fabricated via extrusion process. The substrate 1 is seated on the heat dissipation plate 8. Preferably, the heat dissipation plate 8 is formed with a pair of sliding grooves 81 extending along its longitudinal length thereof. The substrate 1 has two flanges 17 along its edges thereof so that for coupling the two elements during the assembly, the flanges 17 can be inserted slidably into the grooves 81 from one end of the heat dissipation plate 8, thereby retaining the substrate 1 stably on the heat dissipation plate 8. The diffusion shield 9 has semi-circle shape, is connected integrally with the heat dissipation plate 8 so as form one integral piece. Preferably, the diffusion shield 9 is disposed transversely to light emitting path of the illumination unit in order to provide light diffusion effect, as best shown in FIG. 8.

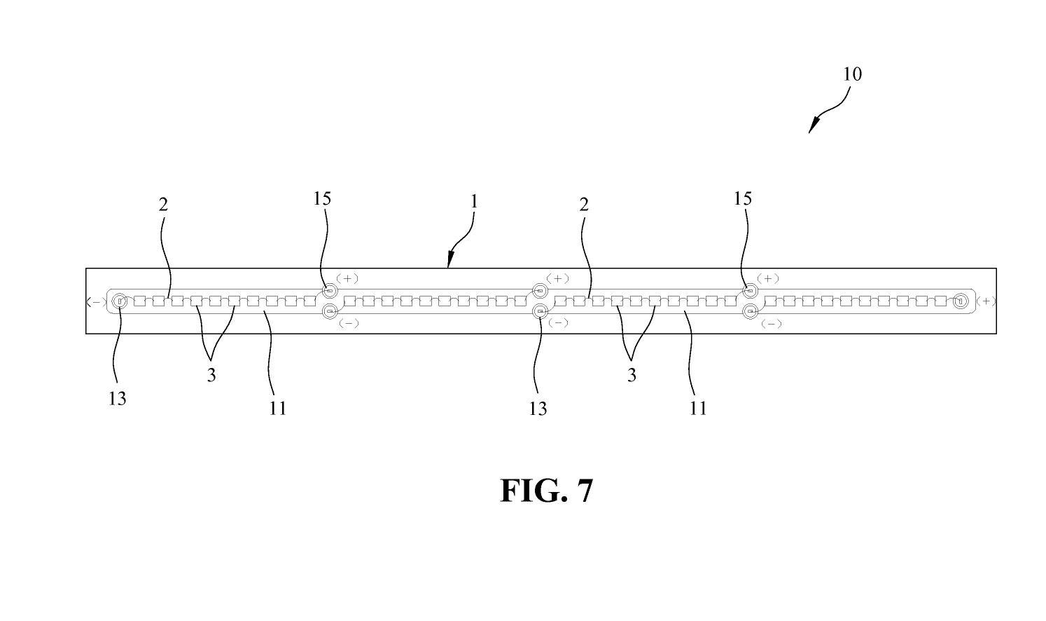

FIG. 7 shows utilization of the substrate in one modified LED light tube of the present invention in a first way, wherein a plurality of illumination units are mounted on the bottom of the recess of the substrate 1. Each of the illumination units is constituted by three pieces of dies wire-bond together in series connection, thereby forming three LED units 3.

Referring to FIG. 8 again, in this embodiment, the LED light tube is formed by a plurality sets of illumination units and a plurality of substrates 1. Each set of illumination units is mounted on a respective substrate 1 as described in the previous embodiment, and the plurality sets of illumination units are connected electrically to one another as best shown in FIG. 8. Under this condition, the LED light tube of the present invention may differ from one another.

The LED light tube of the present provides the following advantages:

1. Note that the recess 11 is relatively narrow in width and since the optical layer and the protection layer only need to cover the relatively small width of the recess 11 for shielding the LED units 3, the cost of material expense is greatly reduced and hence shortening the manufacture time.

2. The number of substrates and the illumination units can be adjusted in accordance with the user requirements; hence the LED light tube of the present invention can be fabricated in different length, thereby facilitating the user.

While the invention has been described in connection with what is considered the most practical and preferred embodiments, it is understood that this invention is not limited to the disclosed embodiments but is intended to cover various arrangement included within the spirit and scope of the broadest interpretation so as to encompass all such modifications and equivalent arrangements.

What is claimed is:

1. A Light Emitting Diode (LED) light tube comprising:
a substrate having a light emitting side formed with a recess and at least one communication hole extending through said substrate; and
at least one illumination unit disposed at a bottom of said recess.

2. The LED light tube according to claim 1, wherein said substrate is made from aluminum.

3. The LED light tube according to claim 1, wherein said recess has two lateral sides, each extending inclinedly from one end of said bottom within a range of 40°˜65°.

4. The LED light tube according to claim 1, wherein said illumination unit is constituted by a plurality of dies wire-bond together in series connection.

5. The LED light tube according to claim 1, further comprising an optical layer covering over said illumination unit, said optical layer being made from fluorescent glue or material mixture consisting of fluorescent glue and silicon resin.

6. The LED light tube according to claim 5, further comprising a protection layer covering said optical layer, wherein said protection layer being made from silicone paste.

7. The LED light tube according to claim 1, further comprising two conductive rods that cooperatively define a conductive member and that extend through said communication holes in said substrate, said conductive rods having top ends connected electrically to said illumination unit.

8. The LED light tube according to claim 7, wherein a silver layer is coated over said top ends of said conductive rods.

9. The LED light tube according to claim 7, wherein a molded compound or encapsulating material is injected into said communication holes in said substrate so as to stably immobilize said conductive rods, wherein said encapsulating material is formed by a combination of silicon resin, liquid crystal polymer (LCP) and epoxy resin.

10. The LED light tube according to claim 9, further comprising an LED driver, said conductive rods having bottom ends connected electrically to said LED driver so as to provide a driving voltage to said conductive rods.

11. The LED light tube according to claim 10, wherein said conductive rods are made from copper.

12. The LED light tube according to claim 1, further comprising a heat dissipation plate made from aluminum having semi-circle shape, said substrate being seated on said heat dissipation plate.

13. The LED light tube according to claim 12, further comprising a diffusion shield having semi-circle shape connected integrally with said heat dissipation plate so as form one integral piece, said diffusion shield being disposed transversely to light emitting path of said illumination unit.

14. The LED light tube according to claim 1, wherein a plurality of said illumination units are disposed on said bottom of said recess.
